(19) United States
(12) Patent Application Publication
(10) Pub. No.: US 2001/0013034 A1
(43) Pub. Date: Aug. 9, 2001

(54) Search system and a search method

(76) Inventor: Yuki Yamauchi, Matsumoto-shi (JP)

Correspondence Address: ARMSTRONG,WESTERMAN, HATTORI,, MCLELAND & NAUGHTON, LLP, 1725 K STREET, NW, SUITE 1000, WASHINGTON, DC, 20006, US

(21) Appl. No.: 09/731,986

(22) Filed: Dec. 8, 2000

(30) Foreign Application Priority Data
Dec. 8, 1999 (JP) 11-349309

(51) Int. Cl. G06F 17/30

(52) U.S. Cl. 707/3; 707/10

(57) ABSTRACT

LS servers to inquire lost pets or something are connected to Internet network. As an example, an owner of a lost pet employs a terminal and inputs characteristic of the lost pet into the LS servers. A discovery person of a pet inputs characteristics of a discovered pet into the LS servers, too. A database with regard to lost pets and a database of the discovery person side are comprised to LS servers. Therefore, A pet agreeing with the characteristics of the lost pet that the owner side inputs is searched, and the information is reported to the owner side. The discovery person side can receive a notice similarly, too.

### BACKGROUND OF THE INVENTION

1. Field of the Invention

The present invention relates to a search system and a search method to be preferred when looking for pets or something.

2. Related Art

Development of communications technology, especially the spread of Internet causes a big change in searching technique of lost pets or something. For example, a lost pet is posted with a photograph, and the person who looked at a homepage can be appealed to for the purchase of a product and information as opposed to a pet by uploading a homepage to a server on Internet.

In addition, each person brings valuable things economically in a certain auction site, and these are posted. The person who wants to buy these negotiates with the person who wants to sell over the manager of the site on Internet. When negotiations have been concluded, the person who wants to buy pays predetermined official fee to the manager, and a sales contract of an article concludes.

As thus described, consumer gets possible to easily search things which are going to be sold by using a communications network, especially Internet than before. In addition, it is not enough about access of the third person because it is a personal homepage, but when having posted a lost pet on the homepage, it gets possible to expect information from the person who was about to look at the pet.

However, even if things or persons that person looks for are clear and definite so far, it is necessary to make a homepage and to upload information in this homepage. And it is also necessary to wander about on an existing “sold” bulletin board and to access site of auction frequently to look for.

### SUMMARY OF THE INVENTION

Thus the object of the present invention is to provide a search system and a search method that can be inquired about lost things such as lost pets intensively.

According to this invention, information of a target demanding inquiry with existing things and persons such as a lost pet, a lost camera or a missing acquaintance (a first data) is input along with a second data specifying a person demanding inquiry from a first terminal. Contrary, information that an animal like a pet is discovered and captured, information of a found camera or information of a person whom somebody will look for (a third data) is input along with a fourth data specifying a person showing the things from a second terminal.

And a lost database storing a pair of the first data and the second data and a found database storing a pair of the third data and the fourth data are built. When the first data input from the first terminal was stored in the lost database, the found database is searched by means of this. On the other hand, when the third data input from the second terminal was stored in the found database, the lost database is searched by means of this. And when search results agree (it is included when being similar), through an intermediary or directly the results are told to an opponent, and lost things are handed over to a counterpart, and both are introduced.

And according to this invention, a first data that expresses characteristics of a lost pet can be input along with a second data specifying an owner of the pet from a first terminal. A third data that expresses characteristics of a discovered pet can be input along with a fourth data specifying a pet discovery person from a second terminal. Data input from the first terminal are stored in a database for owner, and data input from the second terminal are stored in a database for discovery person.

It is natural that there can be plural both the first terminals and the second terminals. In addition, it is also natural that a terminal can become the first terminal in one case and it can become the second terminal in the other case, it depends on a purpose of the input.

Data with regard to the lost pets are integrated in the database for owner, and data with regard to the discovered pets are integrated in the database for discovery person. Therefore, an owner looking for the lost pet inputs and stores information with regard to one's pet into the database for discovery person, and it can search. The search results are displayed on owner use pertinence pet displaying means. On the other hand, a discovery person who is going to find an original owner inputs and stores information with regard to a discovered pet into the database for owner, and it can search. The search results are displayed on discovery person use pertinence pet displaying means.

Also by this invention, a pet characteristic data that expresses characteristics of a discovered pet is input along with a discovery person data specifying a pet discovery person in an appointed homepage on Internet from a discovery person side terminal. Then data on such the discovered pet integrate in a database for discovery person. Therefore if an owner side who lost a pet inputs information with regard to one's pet in the homepage on Internet, and it searches, search results are displayed on a homepage by an owner use pertinence pet displaying means.

And more by the present invention, a first data that expresses characteristics of a lost pet can be input along with a second data specifying an owner of the pet. A third data that expresses characteristics of a discovered pet can be input along with a fourth data specifying a pet discovery person. Data on the lost pet are stored in a database for owner, and data on the discovered pet are stored in a database for discovery person. Data with regard to the lost pet are integrated in the database for owner, and data with regard to the discovered pet are integrated in the database for discovery person.

Therefore, if an owner looking for the lost pet inputs information with regard to one's pet into the database for discovery person, and it searches, the search results are displayed on an owner use pertinence pet displaying means. On the other hand, if a discovery person who is going to find an original owner inputs information with regard to the discovered pet into the database for owner, and it searches, the search results are displayed on a discovery person use pertinence pet displaying means.

According to this invention, a pet characteristic data that expresses characteristics of a discovered pet is input from a terminal connected to Internet along with a discovery person data specifying a pet discovery person. A pair of the pet characteristic data on various pets input on this discovery person side input step and the discovery person data is memorized in a database for discovery person.

And an owner side who lost a pet inputs the pet characteristic data that expresses characteristics of one's pet from the terminal connected to Internet. The owner side searches the database for discovery person as a key of a search with the pet characteristic data that expresses characteristics of a lost pet. When it is determined that there is the pet characteristic data that at least one part agreed with the pet characteristic data that the owner side input, the contents are displayed to a search person.

By this invention, a pet characteristic data that expresses characteristics of a discovered pet is input along with a discovery person data specifying a pet discovery person from an appointed homepage on Internet, And a pair of the pet characteristic data on various pets input in this way and the discovery person data is memorized in a database for discovery person that the homepage side prepared. And an owner side who lost a pet inputs the pet characteristic data that expresses characteristics of lost pet from the homepage. When the database for discovery person was searched as a key with this and it is determined that there is the pet characteristic data that at least one part agreed with the lost pet characteristic data, the contents are displayed to a search person on a homepage.

### BRIEF DESCRIPTION OF THE INVENTION

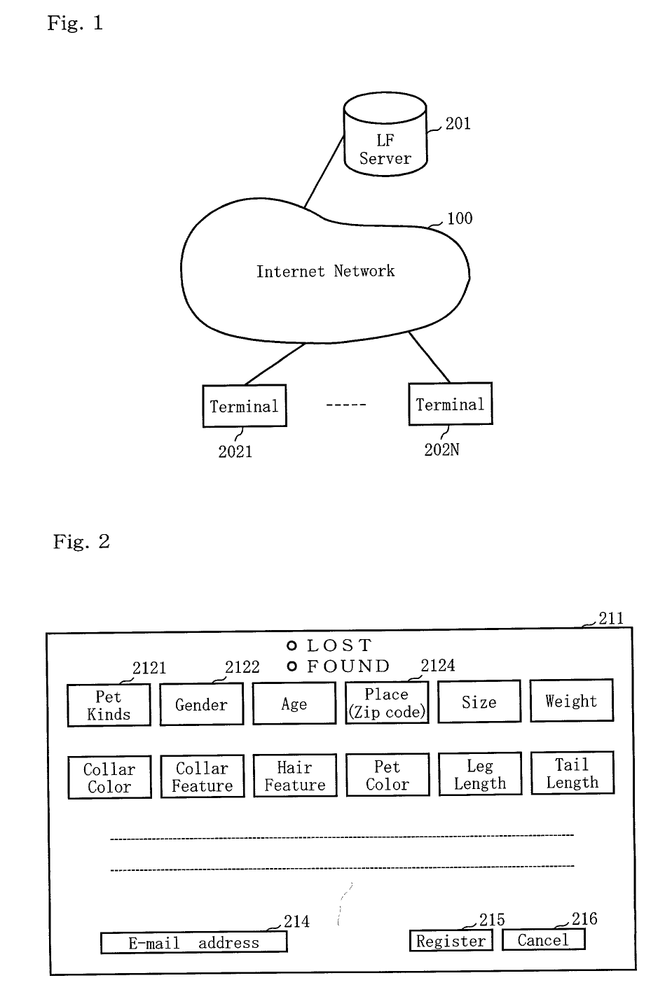

FIG. 1 is a system constitution that expresses an abstract of a search system of an example of the present invention.

FIG. 2 shows the plane view that expresses one example of indication appearing to an indication screen of the terminal that accessed a LF server in an example of the present invention.

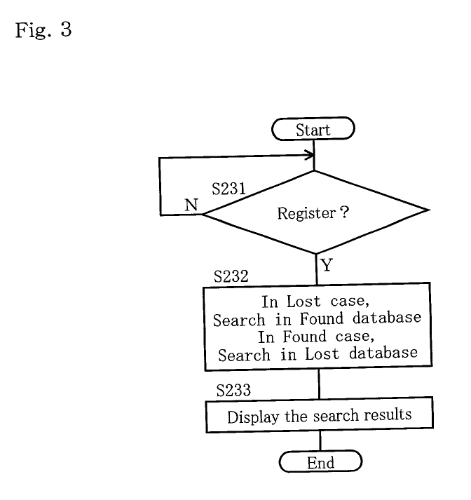

FIG. 3 shows the flow sheet, which expresses search work at a point in time when registration to a database was done in an example of the present invention.

### DETAILED DESCRIPTION OF THE INVENTION

FIG. 1 is an expressing abstract of a search system of an example of the present invention. It is described mainly on inquiry of lost pets here. All kinds of servers such as LF (Lost and Found) server 101 are connected to Internet network 100. Illustration of other LF servers to inquire about is omitted in order to simplify explanation in this figure. Of course it is not necessary for each LF server to be divided according to an animal and a person or lost things, and unification is possible depending on a demand of inquiry appropriately.

Similarly all kinds of terminals are connected to Internet network 100 directly or indirectly over a provider. It is assumed that terminal 2021-202N inputting information of anything with regard to a pet is connected here. Of course even if it is the same computer or information and communication terminal such as a cellular phone machine, when a viewpoint is changed, it can be a terminal of the owner side, and it can be a terminal of the discovery person side. In other words these terminals 202 may be special exclusive terminals, but it may be a completely normal information and communication terminal.

FIG. 2 shows an example of the indication that appeared to an unillustrated indication screen of the terminal when either of terminals accessed a LS server. When having accessed an appointed homepage for a pet search on LF server 101, such displaying on the screen is done as normal indication of URL (uniform resource locators) of a homepage.

At first the person who accessed this homepage marks either of “LOST” or “FOUND”. If a dog of a pet was lost now, the person marks “LOST”. As against this, the person who seems to have found a dog marks “FOUND”.

In indication screen 211, plural pull-down menu 2121, 2122 . . . are deployed. These can develop the contents by specifying with a pointing device such as an unillustrated mouse individually, and a desired item can be selected from them.

For example, when pull-down menu 2121 is specified, the pull-down menu that items such as “a dog, a cat, a parakeet, . . . ” are mentioned in is displayed. “A dog” is chosen among these items.

Similarly when pull-down menu 2122 is specified, the pull-down menu that items such as “a male, a female, unknown” are mentioned in is displayed.

When it is impossible to tell a male from a female, an item “unknown” is selected. Then the search that does not limit this item is executed.

In addition, the input of the place where a pet was lost and the place where a pet was discovered is done when pull-down menu 2124 is specified. A zip code is input in the present embodiment, and it gets possible to be changed into this.

There is also the information that cannot specify in pull-down menu 212. Therefore the data is not input about these or, an item “unknown” is selected. In addition, contents of other pull-down menus may become change depending on this when a category of “animal kinds” is selected.

There is an input point 214 of E-mail of a person registering itself in bottom of indication screen 211. Aside from E-mail, a column inputting a phone number and an address may be comprised. When the input of an appointed item is finished, and registration button 215 is pushed, registration or storage is done to an appointed LOST database or a FOUND database of LS server 101. When cancel button 216 was pushed, cancellation of registration is done. In this way the owner who lost a pet registers information to specify the pet with the LOST database, the person who found an animal or the person who took care of an animal registers this with the FOUND database.

FIG. 3 expresses search work at a point in time when registration to a database was done.

The registration or storage is finished (step S231: Y). And when registration or storage is done to the LOST database, a search of the FOUND database is executed about the same condition. On the other hand, a search of the LOST database is executed when registration was done to the FOUND database (step S232). And percent displays the degree of agreements as the search result (step S233). A search person has display an address of a counterpart at need, more detailed information is exchanged, and confirmation can be taken.

The inquiry of a pet was described in the example mentioned above, but the inquiry target is not limited to a specific target such as pets. The things that do not understand the location with a person and a existing creature aside from it can also become targets.

If a homepage for pet inquiry such as the present embodiment is made, it is not necessary to access every homepages, and, in one site or assembled site, inquiry processing can be done effectively. Besides, a database magnifies the contents depending on each demand, and the effect can be raised naturally.

But when irresponsible registration works to a database is forgiven, there may be some information of the pets that have died really on the database. And the cases that delivery is not concluded may increase. Therefore a manager of the site may ensure the information from users by communication means such as E-mails regularly after having registered with the database. It is effective that the registration that confirmation is not got eliminates from the database.

And the reliability of data may be ranked depending on a source of information, for example whether it is registered by an organization in charge of collecting lost pets or not. And it is effective that the rank is displayed with search results and that a color to display the rank is changed depending on the rank.

In addition, it is assumed that a database of an opponent is searched in the example mutually, but only one can do a search of a database directly. When LF server 201 is employed in doing management of commerce, an owner of LF server 201 contacts the owner who lost a pet and the person who found an animal directly. And when a pet is delivered finally, the owner of LF server 201 receives a reward. In this case if it is put as a condition that one part of a reward is given to the person who found a pet or the owner side pays money of thanks to the person who found a pet particularly, this system functions effectively.

Besides, when the owner of LF server 201 manages a database commercially, he may eliminate the data of pets handed over to already in order to remove invalid data, and demand the effectiveness of data existing more than a uniformity period to the person concerned. In this way it is useful in use of a system to get reliability of data.

According to this invention, a database deployed on Internet is filled up by means of increase of input data along with time. Therefore it is easier to make a transaction conclude for the rare target. Besides, when E-mails and Internet are employed and the targets are definite and clear, the load of an intermediary with inquiry can be reduced enough to keep official fee low by devising software of the server side.

In addition, till business is concluded, it is possible for the address information of both inquiring side and inquired side to be easily set be seen mutually. Therefore, both privacy can be kept.

And according to this invention, targets demanding inquiry or search make a common key word, and database for inquiry and database for search are built on a communications network such as Internet. Therefore, it gets possible to inquire and contact easily and with a little expense, though all kinds of medium such as television, radio, newspapers and handbills are employed and spent extremely large expense for inquiry and contact before. Besides, inquiry and search of all kinds of target are possible with using a terminal and doing over a communications network for the world.

What is claimed is:

1. A search system, comprising:
(a) a first terminal which inputs a first data specifying a target demanding inquiry about lost things along with a second data specifying a owner demanding inquiry about lost things;
(b) a second terminal which inputs a third data specifying a target demanding inquiry about discovered things along with a fourth data specifying a discovery person demanding inquiry about discovered things;
(c) a lost database which stores a pair of said first data and said second data about various targets;
(d) a found database which stores a pair of said third data and said fourth data about various targets;
(e) a search means for owner searching the found database by means of the first data input by said first terminal; and
(f) a search means for discovery person searching the lost database by means of the third data input by said second terminal,
wherein, when it is determined that there is the third data which agreed with the first data in said found database by said search means for the owner, an information means addressed to the discovery person tells about there being a target demanding inquiry by means of said fourth data, and
when it is determined that there is the first data which agreed with the third data in said lost database by said search means for the discovery person, an information means addressed to the owner tells about there being a target demanding inquiry by means of said second data.

2. A search system, comprising:
(a) a first terminal which inputs a first data which expresses characteristics of a lost pet along with a second data specifying an owner of the pet;
(b) a second terminal which inputs a third data which expresses characteristics of a discovered pet along with a fourth data specifying a pet discovery person;
(c) a database for owner that stores a pair of said first data and said second data about various pets;
(d) a database for discovery person that stores a pair of said third data and said fourth data about various pets;
(e) a search means for owner that searches the database for discovery person by means of the first data input by said first terminal; and
(f) a search means for discovery person that searches the database for owner by means of the third data input by said second terminal;
wherein, when it is determined that there is the third data that at least one part agreed with the first data in said database for discovery person by said search means for owner, an owner use pertinence pet displaying means displaying the contents to a search person, and
when it is determined that there is the first data that at least one part agreed with the third data in said database for owner by said search means for discovery person, a discovery person use pertinence pet displaying means displaying the contents to a search person.

3. A search system, comprising:
(a) a discovery person side terminal which inputs a pet characteristic data which expresses characteristics of a discovered pet along with a discovery person data specifying a pet discovery person in an appointed homepage on Internet;
(b) a database for discovery person which stores a pair of said pet characteristic data and said discovery person data on various pets input by the discovery person side terminal and connected to this discovery person side terminal with Internet;
(c) an owner side terminal that the owner side who lost a pet inputs in said homepage on Internet; and
(d) a search means for owner which searches said database for discovery person on the basis of the pet characteristic data which expresses characteristics of a lost pet input by this owner side terminal,
wherein when it is determined that there is the pet characteristic data that at least one part agreed with the pet characteristic data which the owner side input in said database for discovery person by this search means for owner, an owner use pertinence pet displaying means displaying the contents to a search person on said homepage.

4. A search method, comprising the steps of:
(a) inputting a first data which expresses characteristics of a lost pet along with a second data specifying an owner of the pet;
(b) inputting a third data which expresses characteristics of a discovered pet along with a fourth data specifying a pet discovery person;
(c) storing a pair of said first data and said second data in a database for owner when there is the input in step (a);
(d) storing a pair of said third data and said fourth data in a database for discovery person when there is the input in step (b);
(e) searching the database for discovery person by means of the first data which expresses characteristics of a lost pet;
(f) searching the database for owner by means of the third data which expresses characteristics of a discovered pet;
(g) displaying contents to a search person when it is determined that there is the third data that at least one part agreed with the first data in said database for discovery person by step (e); and
(h) displaying contents to a search person when it is determined that there is the first data that at least one part agreed with the third data in said database for owner by step (f).

5. A search method, comprising the steps of:
(a) a discovery person side inputting a pet characteristic data which expresses characteristics of a discovered pet from a terminal connected to Internet along with a discovery person data specifying a pet discovery person;
(b) a database memory storing a pair of said pet characteristic data and discovery person data on various pets input in this discovery person side input step in a database for discovery person;
(c) an owner side who lost a pet inputting a pet characteristic data which expresses characteristics of a pet from a terminal connected to Internet;
(d) searching said database, wherein the pet characteristic data which expresses characteristics of the pet which the owner side lost is turned into a key in this owner side input step, and search said database for discovery person; and
(e) indicating a pertinent pet to a search person displaying contents when it is determined that there is the pet characteristic data that at least one part agreed with the pet characteristic data which the owner side input into said database for discovery person in the search step.

6. A search method, comprising the steps of:
(a) a discovery person side inputting a pet characteristic data which expresses characteristics of a discovered pet along with a discovery person data specifying a pet discovery person from an appointed homepage on Internet;
(b) a database memory storing a pair of said pet characteristic data and said discovery person data on various pets input in this discovery person side input step in a database for discovery person prepared by the homepage side;
(c) an owner side who lost a pet inputting the pet characteristic data which expresses characteristics of a pet from said homepage;
(d) a searching said database, wherein the owner side turns the pet characteristic data which expresses characteristics of a lost pet into a key in this owner side input step, and search said database for discovery person; and
(e) indicating a pertinent pet to a search person displaying contents on said homepage when it is determined that there is the pet characteristic data that at least one part agreed with the pet characteristic data which the owner side input into said database for discovery person in this search step.
